(19) United States
(12) Patent Application Publication
(10) Pub. No.: US 2008/0022034 A1
(43) Pub. Date: Jan. 24, 2008

(54) Segmentation for a flash memory of a flash disc

(75) Inventor: Chih Wen Cheng, Zhubei (TW)

Correspondence Address: BACON & THOMAS, PLLC, 625 SLATERS LANE, FOURTH FLOOR, ALEXANDRIA, VA, 22314, US

(73) Assignee: DDTIC Corporation, Ltd., Zhubei City (TW)

(21) Appl. No.: 11/489,557

(22) Filed: Jul. 20, 2006

(51) Int. Cl. G06F 12/00

(52) U.S. Cl. 711/103; 711/115; 711/173

(57) ABSTRACT

A segmentation design for dividing the flash memory of a flash disc into three segments A, B and C, or more segments. Segment A is a control area, segment B (only readable but not writable to ordinary user) is a storage area particularly for storing the special program and data offered by the product manufacturer, and segment C is a storage space readable and writable to ordinary users. Stored in the segment A are: 1. memory brand, specification, size, and segmentation information, etc, 2. information of the product manufacturer, 3. account number and password set by the user, 4. settings of the device description for segment B, and 5. settings for the readable and writable area. A verifying program will display a dialog frame on the personal computer screen, asking the user to enter account number and password before entering the segment C, and only one device will be displayed on a personal computer screen after insertion of the flash disc.

### FIELD OF THE INVENTION

The present invention relates to a segmentation method for a flash memory of a flash disc, and more particularly to a method for dividing the flash memory of the flash disc into three or more segments.

### BACKGROUND OF THE INVENTION

Flash disc has become a commonly used tool of the personal computer user ever since it came out in 1998. The memory size of the flash disc approximately ranges from 128 MB to 512 MB, and the flash disc is very convenient to use.

The flash memory of the flash disc is a memory device. When the flash disc is inserted into the USB port, the personal computer will regard it as a disc device. And like the disc drive, the flash disc can be shown on the screen of the personal computer for enabling the personal computer user to save data in the flash disc or use the data saved in the flash disc freely.

Lately, HAGIWARA SYS-COM in Japan made an improvement to the flash memory of the flash disc, as shown in FIG. 1. The flash disc 1 includes a control chip 11 and a flash memory 12. The flash memory 12 is divided into two parts: Lun 0 and Lun 1. Lun 0 is designed to be a read-only CD ROM for storing medium data or software program. The operating system is used to read or execute the medium data or software program stored in the CD, thus achieving a function of auto-run. The Lun 1 serves as an ordinary flash memory that is readable and writable. When this flash disc is inserted into the USB port, the personal computer will regard it as two different disc devices and display them on the screen. The personal computer user can save data in the Lun 1 or use the data saved in the Lun 1 freely, while the user can't store data in the Lun 0 but can only read the data stored in the Lun 0, or the Lun 0 can be designed to run the medium data or software program thereof automatically.

As shown in FIG. 2, wherein the CD drive (F:) 22 is the original CD drive of the personal computer, the DVDICDRW drive (E:) 21 is an icon produced after the user installs a virtual drive. After a flash disc is inserted into the USB port of the personal computer, the following two icons will be displayed on the personal computer: AURORUN (H:) 24 and removable disc (I:) 25, representing Lun 0 and Lun 1 respectively. However, the DVD/CDRW drive (E:) 21 and the AURORUN (H:) 24 will confuse the personal computer. When the user wants to run the read-only CD ROM of the Lun 0, the personal computer can't correctly choose the AURORUN (H:) 24.

When the user sets up a card reader in the personal computer, an icon of removable disc (G:) 23 will be created. In this condition, after this flash disc is inserted into the USB port of the personal computer, the following two icons will be displayed on the personal computer: AURORUN (H:) 24 and removable disc (I:) 25, representing Lun 0 and Lun 1 respectively. However, the removable disc (G:) 23 and the removable disc (I:) 25 will confuse the personal computer. When the user wants to run the readable and writable flash memory of the Lun 1, the personal computer can't correctly choose the removable disc (I:) 25.

Obviously, HAGIWARA SYS-COM's design is still not ideal, since the two icons (devices) displayed on the computer after insertion of the flash disc are similar to the original devices. It causes confusion. Furthermore, it doesn't have the design of account number and password, the data in the Lun 1 is accessible to everyone, therefore, it is not safe.

The present invention has arisen to mitigate and/or obviate the afore-described disadvantages.

### SUMMARY OF THE INVENTION

The primary objective of the present invention is to provide a method for dividing the flash memory of the flash disc into three segments A, B and C, or more segments. Segment A is a control area, segment B (only readable but not writable to ordinary user) is a storage area particularly for storing the special program and data offered by the product manufacturer, and segment C is a storage space which is readable and writable to ordinary users. Stored in the segment A are: 1. memory brand, specification, size, and segmentation information, etc, 2. information of the product manufacturer, 3. account number and password set by the user, 4. settings of the device description for segment B, and 5. settings for the readable and writable area.

After the flash disc is inserted into a personal computer, the control chip of the flash disc, based on data pre-stored in the segment A of the flash memory, will report device class to the personal computer (e.g. declare a CD drive or other disc drive), and the operating system will read or execute the medium data or software program for auto-running, a verifying program will be executed by the operating system for displaying a dialog frame on the personal computer screen, asking the user to enter account number and password, and then ask the user to choose to enter segments B or C, if the user chooses the segment B, the personal computer will read medium data or software program stored in the segment B; if the user chooses segment C, the user will be free to save data in the segment C or use the data saved in the segment C. Whatever the user chooses segments B or C, the personal computer will only show one device on the screen.

### BRIEF DESCRIPTION OF THE DRAWINGS

FIG. 1 is an illustrative view for showing HAGIWARA SYS-COM's improvement to the flash memory of a flash disc;

FIG. 2 shows that two devices are shown in the screen after inserting the HAGIWARA SYS-COM's flash disc into a personal computer;

FIG. 3 is an illustrative view for showing the segmentation of the flash memory of the flash disc in accordance with the present invention;

FIG. 4 is a flow chart in accordance with the present invention for showing the operating procedures after insertion of the flash disc of the present invention into a personal computer;

FIG. 5 shows that only one device is shown on the screen after insertion of the flash disc of the present invention into a personal computer.

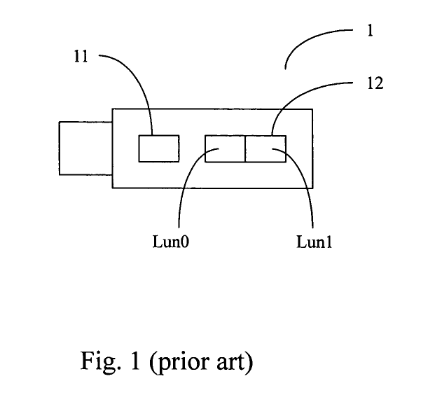

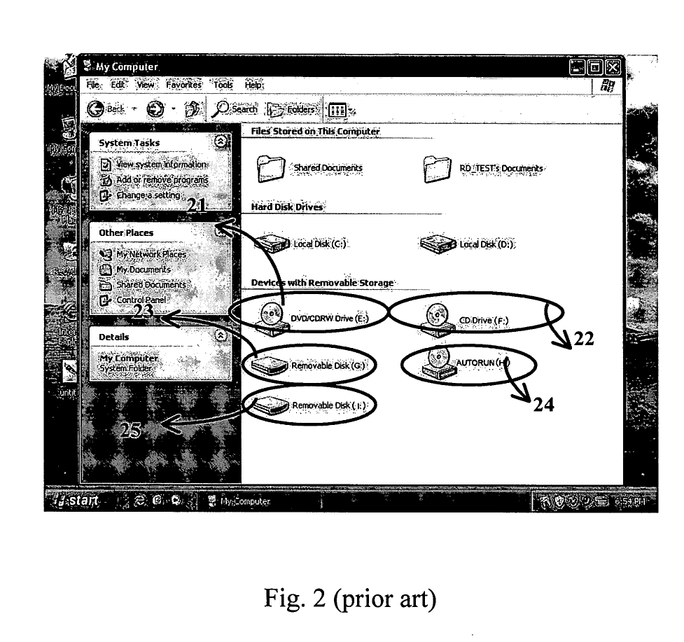

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

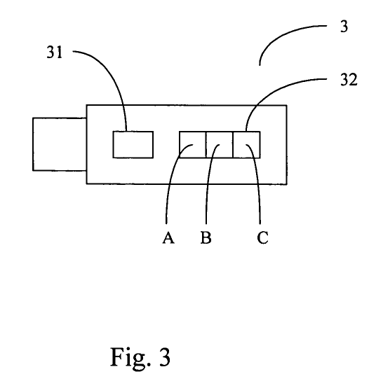

Referring to FIG. 3, which is an illustrative view for showing the segmentation of the flash memory of a flash disc in accordance with the present invention. The flash disc 3 includes a control chip 31 and a flash memory 32. The flash memory 32 is divided into three segments A, B and C, or more segments: Segment A is a control area, segment B (only readable but not writable to ordinary user) is a storage area particularly for storing the special program and data offered by the product manufacturer, and segment C is a storage space which is readable and writable to ordinary users. Stored in the segment A are: 1. memory brand, specification, size, and segmentation information, etc, 2. information of the product manufacturer, 3. account number and password set by the user, 4. settings of the device description for segment B, and 5. settings for the readable and writable area.

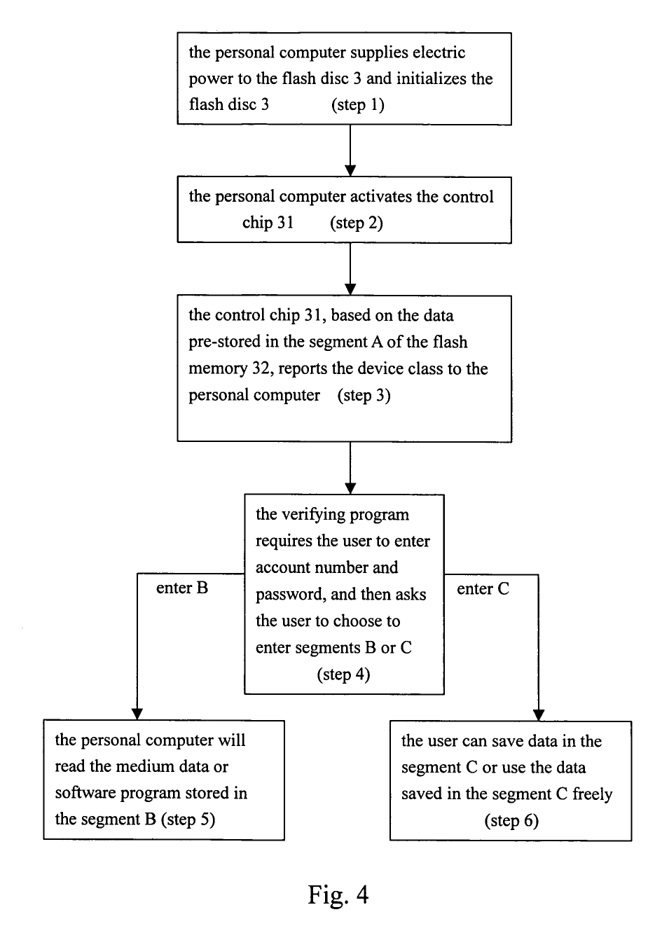

After the flash disc 3 is inserted into the USB port, the following steps will be executed as shown in FIG. 4: firstly, the personal computer supplies electric power to the flash disc 3 and initializes the flash disc 3 (step 1); and then activates the control chip 31 (step 2); the control chip 31, based on the data pre-stored in the segment A of the flash memory 32, reports the device class to the personal computer (step 3). After that, the verifying program requires the user to enter account number and password, and then asks the user to choose to enter segments B or C (step 4); If the user chooses the segment B, the personal computer will read the medium data or software program stored in the segment B (step 5); if the user chooses segment C, it will enter the step 6. In step 6, the user can save data in the segment C or use the data saved in the segment C freely.

Since a dialog frame will be displayed in step 4, asking the user to enter the account number and password, thus providing protection to the data saved in the flash memory 32.

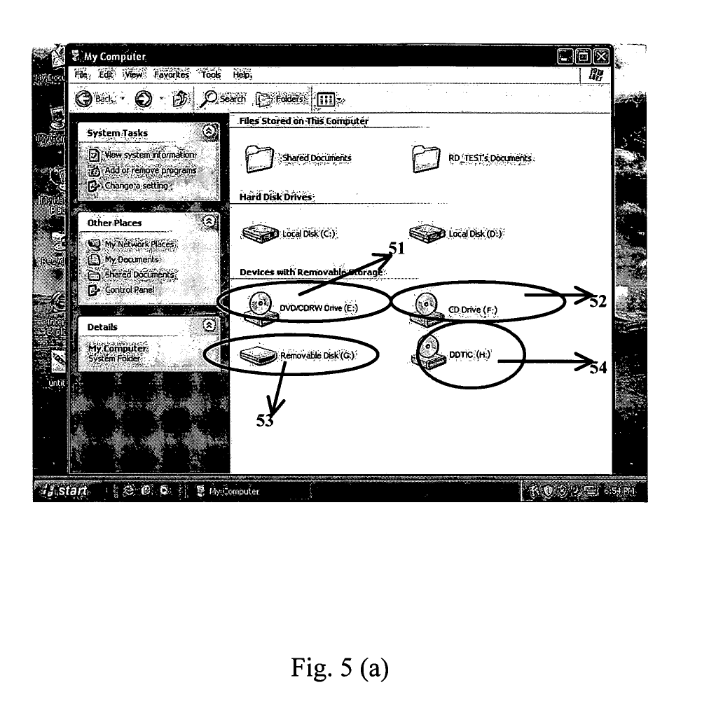

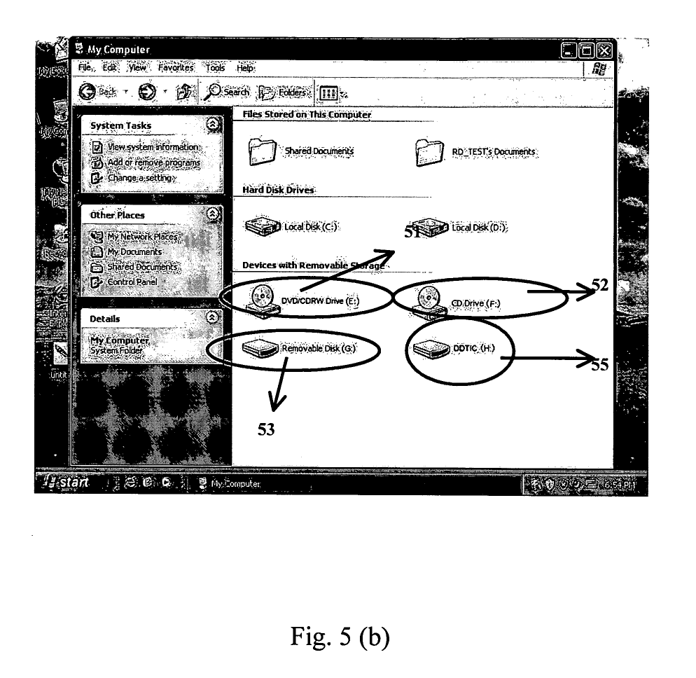

After inserting the flash disc of the present invention in the personal computer, only one device (icon) will be displayed on the screen, as shown in FIG. 5(a), wherein the CD Drive (F:) 52 is an original CD drive of the personal computer, DVD/CDRW drive (E:) 51 is an icon produced after the user installs the virtual drive, and the iron of removable disc (G:) 53 is created after the user sets up a card reader in the personal computer. In this condition, an icon of DDTIC (H:) 54 representing segment A, will be displayed on the personal computer after insertion of the flash disc into the USB port. The personal computer chooses DDTIC(H:) 54 to enter segment A, after executing the above-mentioned steps 1, 2, 3 and 4, and choosing the segment B or C, the DDTIC (H:) 55 will be shown on the screen of the personal computer, which represents the segment B or C and is a removable type disc. And the screen of the personal computer still only shows one icon (device), as shown in FIG. 5(b).

While we have shown and described various embodiments in accordance with the present invention, it is clear to those skilled in the art that further embodiments may be made without departing from the scope of the present invention.

What is claimed is:

1. Segmentation for a flash memory of a flash disc, comprising three segments A, B and C or more, segment A representing a control area, segment B being a read-only segment, and segment C or more representing a readable and writable storage space.

2. The segmentation for a flash memory of a flash disc as claimed in claim 1, wherein the following data are stored in the segment A: 1) memory brand, specification, size, and segmentation information, etc, 2) information of the product manufacturer, 3) account number and password set by the user, 4) settings of the device description for segment B, and 5) settings for the readable and writable area.

3. The segmentation for a flash memory of a flash disc as claimed in claim 1, wherein the segment B is a storage area particularly for storing special program and data offered by product manufacturer.

4. The segmentation for a flash memory of a flash disc as claimed in claim 1, wherein after the flash disc is inserted in a personal computer, a control chip of the flash disc, based on data pre-stored in the segment A of the flash memory, will report device class to the personal computer, after that, a verifying program will display a dialog frame on the personal computer screen, asking the user to enter account number and password, and then asking the user to choose to enter segments B or C, if the user chooses the segment B, the personal computer will read medium data or software program stored in the segment B; if the user chooses segment C, the user will be free to save data in the segment C or use the data saved in the segment C.

5. The segmentation for a flash memory of a flash disc as claimed in claim 4, wherein only one device will be displayed on the personal computer screen after insertion of the flash disc.
